(19) United States
(12) Patent Application Publication
(10) Pub. No.: US 2013/0209735 A1
(43) Pub. Date: Aug. 15, 2013

(54) PROTECTIVE MATERIAL HAVING GUARD PLATES WITH IMPROVED SURFACE PROPERTIES

(71) Applicants: Young-Hwa Kim, Hudson, WI (US); Nusrallah Jubran, St. Paul, MN (US); Peter Gottschalk, Maplewood, MN (US); Daniel P. Stubbs, Marine-on-St. Croix, MN (US); Richard D. Olmsted, Vadnais Heights, MN (US)

(72) Inventors: Young-Hwa Kim, Hudson, WI (US); Nusrallah Jubran, St. Paul, MN (US); Peter Gottschalk, Maplewood, MN (US); Daniel P. Stubbs, Marine-on-St. Croix, MN (US); Richard D. Olmsted, Vadnais Heights, MN (US)

(73) Assignee: HIGHER DIMENSION MATERIALS, INC., Oakdale, MN (US)

(21) Appl. No.: 13/817,350

(22) PCT Filed: Aug. 18, 2011
(86) PCT No.: PCT/US11/48312

§ 371 Date: Apr. 25, 2013

Related U.S. Application Data
(60) Provisional application No. 61/401,722, filed on Aug. 18, 2010.

(51) Int. Cl. B32B 3/16

(52) U.S. Cl. CPC B32B 3/16
USPC 428/141; 428/196; 427/256

(57) ABSTRACT

In some examples, the disclosure relates to a fabric assembly comprising a flexible substrate including a top surface; a plurality of plates affixed to the top surface of the flexible substrate and arrayed in a pattern such that a plurality of continuous gaps are defined between adjacent plates; and a coating formed on at least one of the substrate and plurality of guard plates, wherein the coating is selected to increase at least one of scuff resistance, oil resistance, water resistance, stain resistance of the fabric assembly.

### TECHNICAL FIELD

In some examples, the disclosure relates to protective fabric materials that can be used in clothing, gloves, boots, furniture, transportation seating, and other applications where fabric is commonly used, having a surface with a desired level of scuff resistance, water resistance, oil resistance, and/or resistance to permanent marking with paint or dye solutions.

### BACKGROUND

None.

### SUMMARY

SuperFabric® is a family of fabric assemblies with a variety of unique features. SuperFabric® may comprise a woven or non-woven base fabric material onto which guard plates have been attached. Water resistance, oil resistance and stain resistance and greater ease of cleaning of guard plates and the base fabric of the assembly may be improved by coating SuperFabric® with appropriate materials. Additionally or alternatively, these coatings may also improve the scuff resistance of the surface, where scuff resistance is understood to mean distortion, disruption, or damage to a surface that does not result from removal of material from the surface. Such coatings may also facilitate control over aspects of the surface's visual appearance. For example, coatings can include filler materials that make the surface look matte or glossy. Coatings can be carriers for paint color pigments and thus can be used to control the color of the surface. The color pigment can include UV absorbing material to extend the longevity of the coating in outside applications.

The guard plates in the structure of SuperFabric® may provide a platform for altering the appearance of SuperFabric®. Each plate can bear an image or portion of an image that taken individually or as a collection carries visual information. It is to be understood that image and portion of an image can be used interchangeably for the purposes of this disclosure. Moreover, the term image need not be constrained to those rendered only in the visible light spectrum. Image is intended to refer to electromagnetic radiation of any frequency that can be rendered by any means. Examples may include, but are not limited to radar images, infrared images, ultraviolet images, and the like.

Once an image has been placed on a plate, one or more coatings may be applied to protect the image itself. SuperFabric® plates may be durable, but the image thereupon may not be. To protect such images, a coating may be applied on top of the image such that the image material is located between the plate and the coating.

In one example, the disclosure relates to a fabric assembly comprising a flexible substrate including a top surface; a plurality of plates affixed to the top surface of the flexible substrate and arrayed in a pattern such that a plurality of continuous gaps are defined between adjacent plates; and a coating formed on at least one of the substrate and the plurality of guard plates, wherein the coating is selected to increase at least one of scuff resistance, oil resistance, water resistance, stain resistance of the fabric assembly.

The concept of image as used in this disclosure includes but is not limited to any pattern affecting any portion of the electromagnetic spectrum. For example, small wavelength gratings that limit reflection of visible light from a surface would be regarded as an image. Patterns discernible only by electron microscopy would be regarded as an image, and so forth.

Such patterns can be formed in a variety of ways including but not limited to laser ablation, plasma treatments that actually change the chemical composition of the surface, nano-imprinting techniques, nano-patterning techniques by modification of e-beam lithography, or chemical etching.

In another example, the disclosure relates to a fabric assembly comprising a flexible substrate including a top surface; and a plurality of plates affixed to the top surface of the flexible substrate and arrayed in a pattern such that a plurality of continuous gaps are defined between adjacent plates, wherein the plates have a modified surface to form a selected image, wherein the modified surface includes at least one of a surface altered via altering the chemistry of the surface, a surface altered via texturing of the surface, or a surface altered via application of a material to the surface.

### BRIEF DESCRIPTION OF THE DRAWINGS

FIGS. 1a-d are conceptual diagrams illustrating four separate example construction types for example coated SuperFabric®. For example, FIG. 1a shows a coated support fabric coated which may provide one or more benefits, e.g., water or oil resistance with guard plates printed on the coated fabric. FIG. 1b shows a coating over the top of a finished SuperFabric® structure. This construction may combine stain and water or oil resistance with scuff resistance and superior cleanability. FIG. 1c shows a coating applied only to the tops of the guard plate. This construction type may retain the air breathability of the SuperFabric® material with the improvements in scuff resistance due to the coating. FIG. 1d shows the coating applied to the tops of the guard plates as well as to the bottom of the base fabric itself. The application to the base fabric may be prior to printing the guard plates or after the printing of the guard plates.

FIG. 2 is a conceptual diagram illustrating an example decorative image on a SuperFabric® surface that has been protected from scuffing, abrasion and/or environmental degradation by a coating of material applied over the surface of the image. The example decorative image may be applied by a dye sublimation process, or an inkjet printer, for example. Or, in another example, the image could be a holographic image that has been heat transferred onto the guard plate top surfaces prior to their curing. Such holographic and other colorful coatings may be available on heat transfer backings.

FIG. 3 is a conceptual diagram illustrating an example decorative holographic image on the top surface of the guard plates and protected by a coating.

FIG. 4 is a flow diagram illustrating an example technique for making a holographic or other foil coating on the top surface of guard plates and subsequently protecting the resulting fabric with a suitable coating. One specific example of a polyurethane coating is shown in the FIG. 4, but this disclosure is not limited to this example.

FIG. 5 is a flow diagram illustrating an example technique for making an image on guard plates via a dye sublimation process and subsequently protecting the image with a suitable coating. The specific example of a polyurethane coat is shown in the FIG. 5, but this disclosure is not limited to this example.

FIG. 6 is flow diagram illustrating an example technique for nano-etching using the specific example of an electron beam with an anodized aluminum oxide template.

FIGS. 7A-7G are conceptual diagrams illustrating various examples guard plates shapes.

FIGS. 8A and 8B are conceptual diagrams illustrating two example gap width-to-guard plate size aspect ratios.

FIGS. 9A-9D are conceptual diagrams illustrating various example guard plate shapes and example guard plate geometries.

FIGS. 10A-10D are conceptual diagrams illustrating various example cross sections for example guard plates.

FIGS. 11A and 11B are conceptual diagrams illustrating example guard plates arranged on a fabric substrate from perspective view showing the 3-dimensional nature of the example guard plates.

### DETAILED DESCRIPTION

SuperFabric® (commercially available from Higher Dimension Materials, Oakdale, Minn.) may be a family of fabric assemblies with a variety of unique features. In some examples, SuperFabric® may comprise a woven or non-woven base fabric material onto which guard plates have been attached. Examples of articles including a woven or non-woven base fabric material may include one or more examples described in U.S. Pat. No. 6,962,739, entitled “Supple Penetration Resistant Fabric and Method of Making;” U.S. Pat. No. 7,018,692, entitled “Penetration Resistant Fabric with Multiple Layer Guard Plate Assemblies and Method of Making the Same;” published U.S. Patent Application No. 2004/0192133, entitled “Abrasion and Heat Resistant Fabrics;” and published U.S. Patent Application No. 2009/014253, entitled “Supple Penetration Resistant Fabric and Method of Making.”

As will be described further below, in some examples, SuperFabric® may include guard plates ranging in size and shape, and in overall geometrical arrangement. Guard plate sizes may range from approximately 20 to approximately 200 mils (approximately 0.508 mm to approximately 5.08 mm) with gap areas between guard plates ranging from approximately 5 to approximately 50 mils (approximately 0.127 mm to approximately 1.27 mm), although sizes outside these ranges may be used in other examples. Guard plates may range in thickness from approximately 5 to approximately 40 mils (approximately 0.127 mm to approximately 1.02 mm), although thicknesses outside of this range may be used in other examples. In some examples, the guard plate material partially penetrates into the base fabric material and is therefore bonded or otherwise attached to the base fabric substrate. In some examples, the net result of the SuperFabric® construction may be to provide a fabric with local hardness and abrasion resistance while maintaining other useful aspects of fabric such as flexibility, i.e., its ability to conform to arbitrary shapes, and vapor permeability of the base fabric material.

In some examples, guard plates may be constructed of a variety of composite materials, such as cured epoxies, polyurethanes, hybrid of cured epoxy-polyurethane, etc. composited with wear and strength enhancing materials such as silicon dioxide, aluminum oxide, titanium oxide and other filler materials such as pigments.

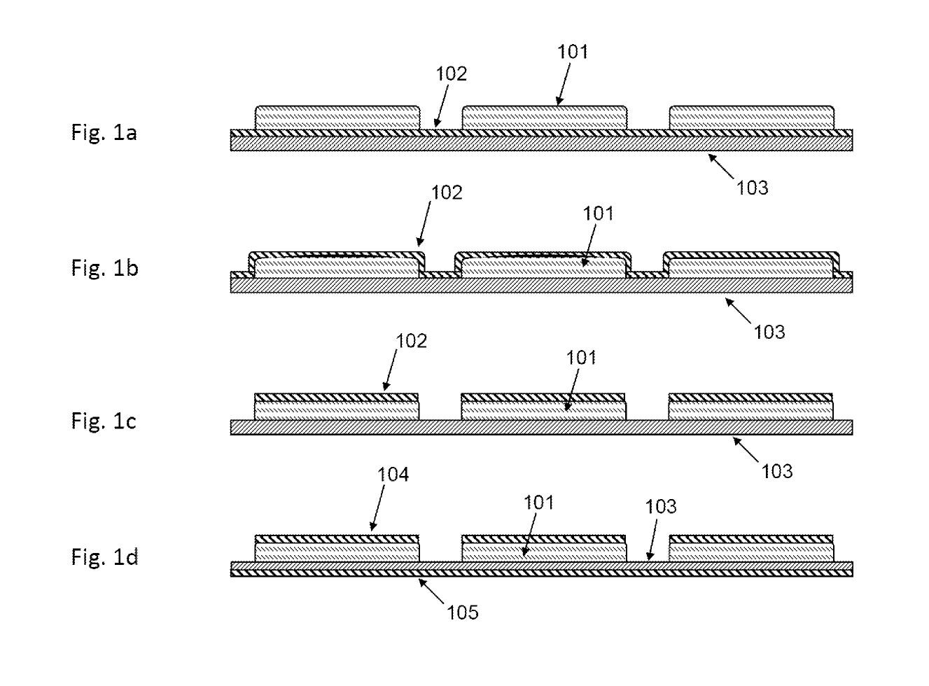

FIGS. 1a-d are conceptual diagrams illustrating four separate example construction types for coated SuperFabric®. Each assembly of FIGS. 1a-d includes fabric substrate 103 including a plurality of guard plates 101 attached to and protruding out of the top surface of substrate 103. Coating 102 is formed on at least one of substrate 103 and guard plates 101.

In construction as shown in FIG. 1a, the properties of the SuperFabric® base fabric material 103, can be altered by coating the base fabric before or after the printing of the guard plates 101. For example, if a water proof SuperFabric® is desired, the underlying fabric 103 can be made waterproof by coating a suitable polyurethane formulation 102, on the fabric before or after guard plates 101 are provided on surface of fabric 103. This construction may be useful for applications such as golf cart seat coverings where it is desirable to spray water on the seats without getting the inside of the seat cushions wet. In some examples, it has been observed that the printing of guard plates can be affected by a polyurethane coating of the base fabric before guard plate printing. For example, a high surface energy polyurethane coating applied to the base fabric material before the forming of epoxy based guard plate resins causes the shapes of the guard plates to be changed from the shapes obtained on uncoated base fabric material.

The example constructions shown in FIG. 1b and FIG. 1c differ by whether or not the coating 102 is present in the gaps between respective adjacent guard plates 101. For example, if a relatively soft polyurethane is used, these constructions will exhibit low scuff resistance. An example of such a soft polyurethane is Sancure 835 from Lubrizol that has a Sward Rocker Hardness of about 4 (ASTM D2134-93(2007)). A harder polyurethane such as Sancure 898 can provide more protection against scuffing and has a Sward Rocker Hardness of approximately 48. Sancure 2036 has a Sward Rocker Hardness of 14. The hardness of a coating can be modified by the addition of a cross linking agents such as polyaziridines or isocyanates to the formulation. The harder polyurethane coatings also inhibit the surface attack of solvents and solvent based ink systems thereby providing stain resistance. Such coating may also facilitate the cleaning of the resulting fabric surface with a solvent based cleaner. UV curable polyurethane coatings can also be applied by hand (brush, spray) or within a coating process (spray, roll coating) followed by UV exposure. UV curable polyurethane dispersions are especially applicable to these constructions.

The constructions shown in FIG. 1b and FIG. 1c can also enhance the resistance to water, oil and solvent based paints and dyes by choosing coating 102 formulations with low surface energies. Topically applied water, with a surface energy of 73 dynes/cm will not easily wet out or penetrate a fabric with epoxy guard plates and narrow gaps, e.g. from 5 to 15 mils (0.127 mm to 0.381 mm), for epoxies having a surface energy of 45 to 50 dynes/cm and the contact angle of the water on the epoxy makes penetration into the gap regions unfavorable. For example, a typical surface energy for a polyurethane similar to that of epoxy ranging from 45-50 dynes/cm depending on formulation, the wetting behavior is not noticeably different. However, a FIG. 1b construction with such a polyurethane can enhance the ease in which dirt can be cleaned from the fabric surface by not permitting the dirt to penetrate the base fabric. Even lubricating oils with surface energies ranging from 25 to 35 dynes/cm are found to not easily absorb into SuperFabric® when the gaps widths between adjacent plates are in the 5 to 15 mil (0.127 mm to 0.381 mm) range.

The surface energy of the coating applied to the SuperFabric® may also be adjusted by adding certain components to the coating formulation. For example, the surface energy of a polyurethane coating can be lowered dramatically by the addition of fluorinated additives. Such polyurethane coatings have been proposed for the purpose of facilitating the clean-up of graffiti. Examples of such coating may include those described by Xiadong Wu and Richard Rosen of Rhodia in JCT CoatingsTech, May 2008 [http://findarticles.com/p/articles/mi_hb3226/is_{—}5_{—}5/ai_n29440435/?tag=mantle_skin; content], which reports on formulations that robustly clean up after marking with several colors of Sharpie Marker, Dry Erase Marker, blue spray paint and green enamel paint. In some examples, a blend ratio between 0 and 40 wt % of Polyol F in Polyol A may be successfully coated. The value of the coating's surface energy may be adjusted by this method from that of the base polyurethane to a desirable low level which prevents the absorption of dyes and paints in solvent based contaminants Polyol F (Arcol Polyol F-3040) is available from Bayer MaterialScience AG, 51368 Leverkusen, Germany.

Independent of the surface energy, coatings with high hardness are penetrated less by inks, dyes and dirt contaminants and may also be more robustly cleaned even using a solvent cleaner than those with lower hardness. For example, a cured coating of Sancure 898 (from Lubrizol) with a polyaziridine cross linking agent (e.g. PZ-28 from Polyarziridines, LLC.), is harder than PU coatings such as of Sancure 835 and clean more easily.

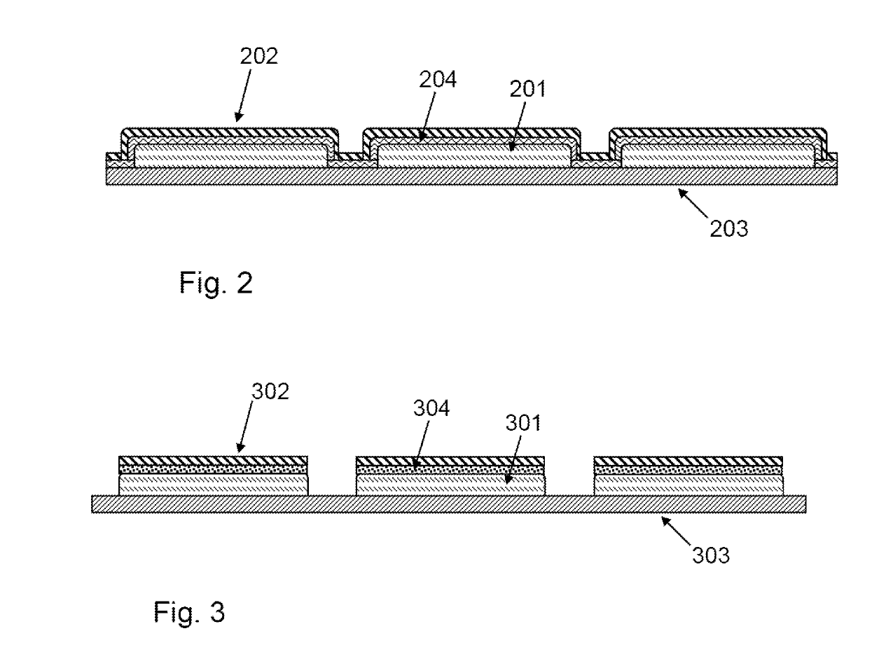

Particularly useful constructions as shown in FIG. 1b and FIG. 1c can be used in conjunction with decorative or functional images. As shown in FIG. 2, such images 204 may be formed on the exposed portions of fabric substrate 203, guard plates 201, and gaps between guard plates 201. Alternatively, as show in FIG. 3, only on the tops of guard plates 301 may be covered by image material 204. In each example, image 204, 304 is covered by coating 202, 302, e.g., a polyurethane coating, such that image 204, 304 separates guard plates 201, 301 from coating 202, 302.

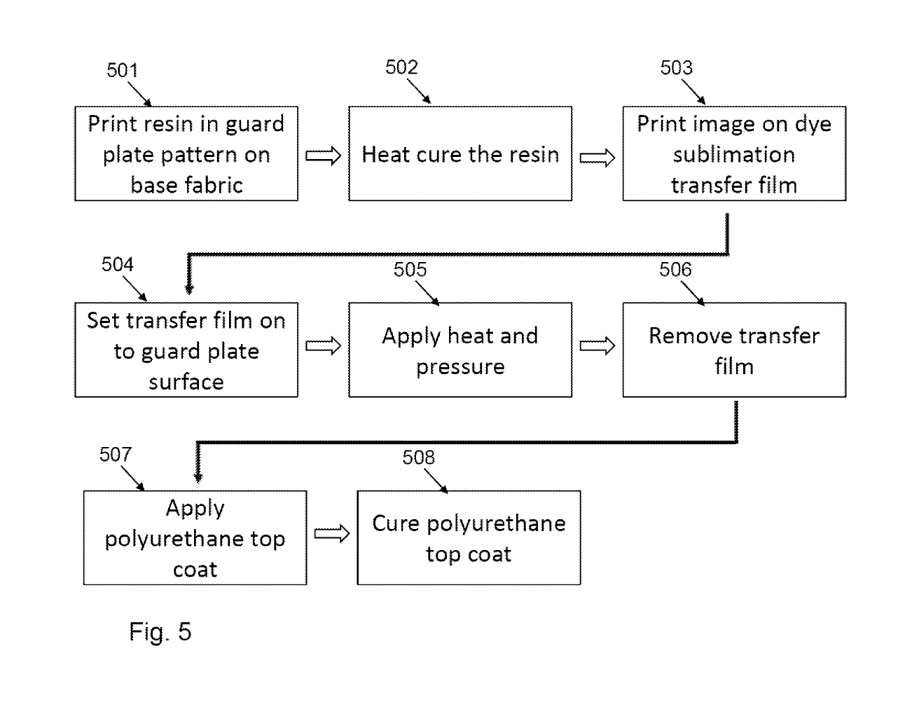

An example of a functional image is a dye sublimation camouflage image applied to the SuperFabric® surface and subsequently overcoated with a durable protective layer of clear polyurethane. For example, Sancure 898 from Lubrizol with a cross linker may be used as the polyurethane overcoating material. An example application for this material is on a hunting or military boot. An example process for producing a polyurethane overcoated dye sublimation image is outlined in FIG. 5.

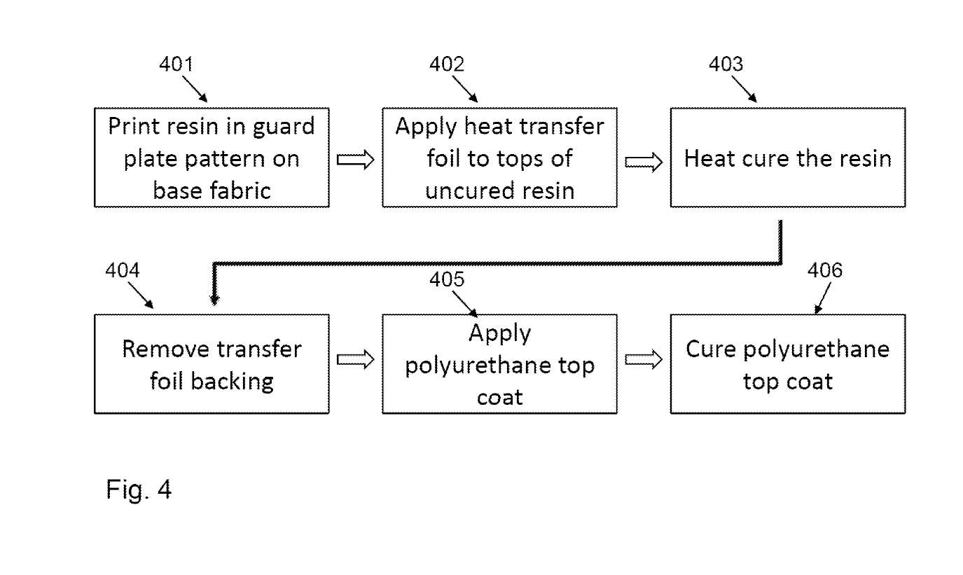

A decorative example of the construction shown in FIG. 1c is shown in FIG. 3, where a holographic or other decorative foil material 304 has been applied on the tops of the guard plates 301 before they are fully cured. An example technique for making such an assembly is shown in the process flow diagram in FIG. 4. This can be accomplished by using a high temperature release liner material that withstands the curing temperature needed for the guard plate to thermally cure. Following the printing of resin onto a fabric substrate (401), the foil with transfer film and release liner film is carefully applied to the surface of the uncured or partially cured epoxy resin guard plates (402). This may flatten or planarize the surface of the guard plates. The base fabric plus printed resin plus release liner foil can then be placed into an oven for thermal curing of the epoxy resin (403). After curing the release liner is removed (404) leaving the image on the tops of the planarized guard plate surfaces and not in the gap areas. The resulting fabric is flexible and decorated. To protect this surface from scuffing and abrasion during use, a durable protective layer of clear polyurethane can be applied (405). An example use for this material is on a purse. See FIG. 3 for a cross section of this construction. FIG. 4 shows a flow diagram of example process of constructing a decorative foil SuperFabric® with a protective polyurethane coating. In some examples, the thickness of the polyurethane coating can range from about 0.5 mils to 2 mils (0.0127 mm to 0.0508 mm), and the thickness may be selected by adjusting the process conditions and by repeated applications of the aqueous PU solution.

The decorative holographic, diffractive, optically interference layered or other decorative foil construction may be particularly beneficial in SuperFabric® constructions designed to thwart counterfeit products. For example, specially designed holographic or diffractive designs can be generated to make foils for attaching to guard plates which incorporate hard to duplicate designs. SuperFabric® materials made with these anti-counterfeit, personalized designs may act to strengthen the anti-counterfeiting measures of many popular products. Examples of this are high end fashion accessories such as purses. Hot transfer foils can be obtained from: ITW Covid Security Group, Inc., 32 Commerce Drive North, Cranbury, N.J. 08512. This is an example of applying a film that has its own inherent structural integrity, optical, and other physical properties to the guard plates in this fabric invention.

A useful example using the assembly construction of FIG. 1d is an asymmetric water passage fabric. In this example, a hydrophobic polyurethane formulation 104 is applied to the tops of the guard plates as shown in FIG. 1d after a hydrophilic, pore filling polyurethane coating 105 has been applied to the base fabric material. The resulting fabric construction will be resistant to water on the top surface with water tending to form droplets on the tops of the guard plates, due to its surface tension, rather than penetrating at the gap locations. In contrast, the bottom surface can be made allow water vapor to pass through. This would be useful for a water resistant item of apparel that would allow water vapor to escape from the skin.

If a yarn encapsulating, but non pore filling, polyurethane coating is applied to the base fabric material in the above example, the composite fabric may resist water infiltration from the top while encouraging water wicking from the bottom.

In some examples, a decorative image 204 as shown in FIG. 2 can be created on top of a SuperFabric® surface by a dye sublimation transfer process. These images may be full color images and could be used on furniture or wall hangings for example. FIG. 5 shows an example process flow diagram for creating a dye sublimation image on a SuperFabric® surface and then protecting that surface with an overcoat layer. Other methods, such as ink-jet printing or flexographic printing, may be used to produce such images on SuperFabric®. Such other image coatings can be similarly protected with the overcoat layer. FIG. 5 explicitly shows a polyurethane coating as an example, but this disclosure is not so limited.

As shown in FIG. 5, polymeric resin for the guard plates may be applied in a desired pattern to a base fabric (501) and then cured (502). Subsequently, a dye transfer sheet is printed (503) with a reverse image of the desired final image, e.g., using a computer controlled printer using special inks. This sheet is placed on the tops of the guard plate surface of the fabric (504) and subjected to appropriate pressure and heat (505). After an adequate dwell period the material is removed from the hot press and the transfer sheet removed (506). The result is an image on the top of the guard plate plus base fabric. This image bearing fabric can then be overcoated (507) with a protective coating such as polyurethane, which is then cured 508, to provide for the characteristics desired: improved scuff resistance and improved resistance to malicious marking or painting, for example.

For all of these constructions, the resulting fabric assemblies may remain flexible. Flexibility means that the fabric assembly can substantially conform to an arbitrary shape suited to the particular application. For example, fabric for a glove conforms to wrap around a finger and allows the wearer's hand to flex at the palm and fingers to grasp an object. For a bus seat, the flexible fabric assembly conforms to the underlying cushion material during seat manufacture and deforms with the cushion when some is sitting on the seat.

For some of these constructions it is desirable to maintain some air breathability. For example, a FIG. 1c construction can be used in a glove where it is desirable to allow air and water moisture to pass through for the comfort of the wearer. Additionally a FIG. 1d construction can be used for a footwear application to allow the fabric to breath. This prevents the foot from becoming uncomfortable due to sweating. At the same time the FIG. 1d fabric resists the penetration of water from the outside of the footwear (the top of the fabric in FIG. 1d.)

Specific examples of the utility of the invention to provide modified surface properties to guard plates and/or substrate materials have been explicitly described for the case of a polyurethane coating. It is clear, however, to one skilled in the art, that the invention is not narrowly confined to the use of polyurethane as a coating material for either the guard plates, the underlying substrate or to both of them. Many embodiments of the invention can be envisioned.

One can recognize that a variety of polyurethane formulations can be used that would vary other physical properties desired in such a coating. Moreover, one need not limit one's attention only to polyurethanes. Examples include epoxy and acrylic formulations or a variety of mixtures that have a range of elastomeric properties all of which can be tuned to control the manner in which the final fabric assembly and construction will interact with its environment. The choice of coating material and attendant fillers, additives, and diluents can be used to control the refractive index of the coating material thereby controlling the nature and amount of electromagnetic radiation that penetrates the coating, is absorbed by the coating, or is reflected by the coating.

An example is the absorption of UV rays that can cause coatings to yellow and weaken structurally through chemical reactions associated with free radical formation. This effect can be minimized by using aliphatic based monomers, oligomers, and polymers in the coating system. Additives which benignly absorb UV rays or react with formed free radicals prolong the coating life and protect the substrate from degradation as well. Examples of UV absorbers are Chimassorb® 81 or Chimassorb® 81FL from BASF. Examples of free radical scavengers are combinations of Tinuvin 360 and Tinuvin 622 SF also from BASF.

Practical applications include but not are limited to limiting UV degradation, limiting infrared radiation reflection, controlling radar reflection, and controlling color.

In some examples, surface properties of guard plates and substrate materials can also be modified by non-wet coating methods. In such cases, the guard plates can be referred to as guard plates with surface modifications. In one example, surface modification can be accomplished by plasma treatment of the guard plates, substrate in the gaps between guard plates, or both, to alter the chemical composition of the surface of the materials exposed to the plasma field. For example, hydrophobicity or hydrophilicity can be affected by altering the presence of such elements as oxygen or fluorine that can be permanently chemically bonded to the surface through such plasma treatments. Practical applications include but are not limited to controlling oil or water absorption, stain resistance, resistance to weathering, and ability to clean the surface that has been treated.

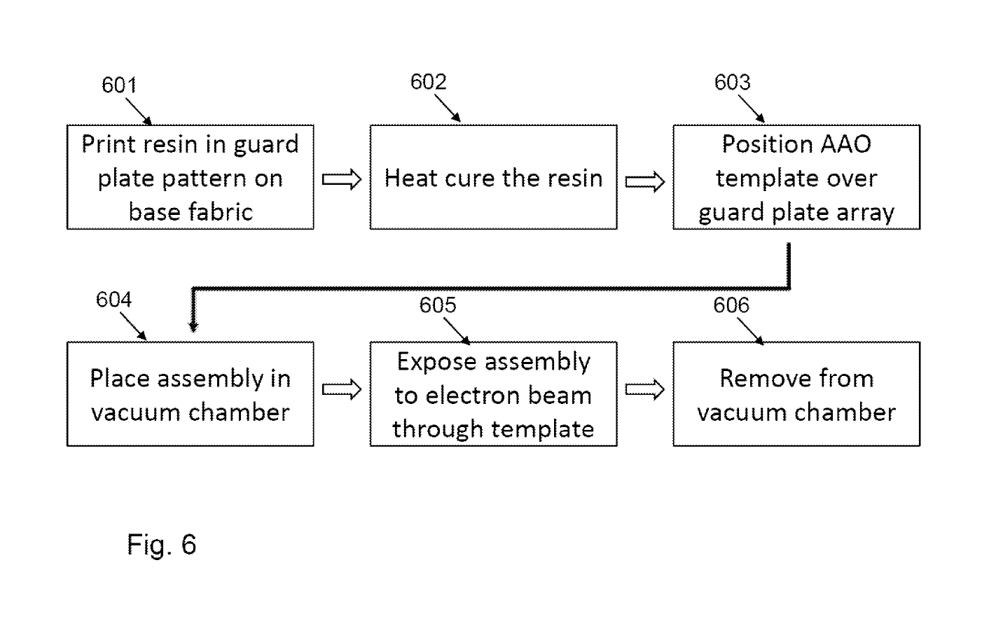

In some examples, surface modification may include laser treatment, nano-imprinting or nano-patterning. For example, laser treatments and nano-imprinting or nano-patterning techniques can be used to control the surface roughness of guard plates and/or substrate materials. Lasers can be used to remove small amounts of material from a portion of a surface and leave a closely neighboring part of the surface untouched. Repeated application of the laser can define a prescribed pattern that will alter dynamic wetting and static wetting behaviors that will affect hydrophobicity. Patterns also affect light reflection and the gloss of a surface in many wavelength regions is affected by its surface roughness. Nano-imprinting or nano-patterning can be applied, for example, by subjecting the material to an electron beam that passes through an anodized aluminum oxide template. The template can have holes through it that are only 20 nanometers in diameter and are spaced in a hexagonal array with average separations of about 100 to 200 nanometers. Such templates are coated with gold leaving the pores exposed so the electron beam can only pass through the pores. This treatment results in a pattern on the guard plates or substrates that has surface roughness on a scale small compared to visible light and can be used to produce a non-reflective surface. This process is exemplified in FIG. 6, where resin for guard plates may be printed onto a fabric substrate (601) and then cured on the base fabric (602). Subsequently, an anodized aluminum oxide template may be positioned over the guard plate array (603). This assembly may then be placed in a vacuum chamber (604), exposed to electron beam through the template (605), and then removed from the vacuum chamber (606). Such a process may be used, e.g., to provide for a desired surface roughness and/or other desired surface modification. Many other applications may also evident to those skilled in the art.

Another way to coat guard plates or substrates is by using sputtering or chemical vapor deposition. Gold and other precious metals are often coated on surfaces by sputtering techniques. Amorphous diamond can be applied by chemical vapor deposition to enhance wear properties and lubricity of the surfaces to which it is applied.

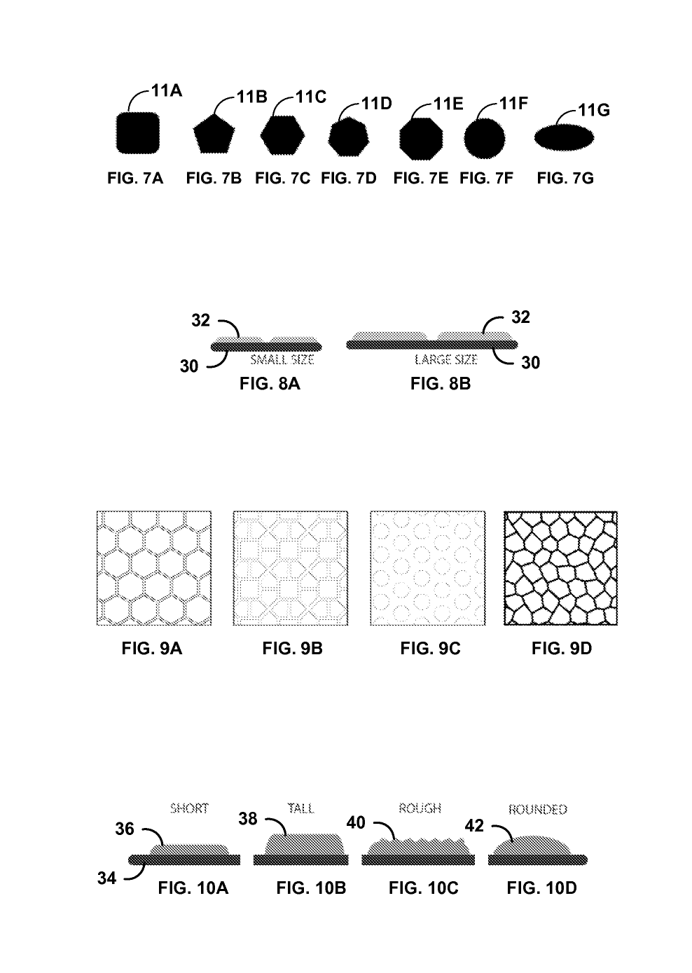

As described above, some examples of this disclosure generally relate to fabric assemblies (which may be referred to as “Superfabric®”) including a plurality of guard plates formed on the surface of a fabric substrate. Aspects of some examples of such fabric assemblies are described below with regard to FIGS. 7-12

Example fabric types for flexible fabric substrate 12 (FIGS. 11A and 11B) may include, but are not limited to, woven, non-woven, or knit fabrics having the ability to permit at least partial penetration of uncured resin used to form polymeric guard plates 14 after deposition of the uncured polymer on fabric substrate 12. Fabric materials include without limitations cotton and cotton-polyester blends and other natural and man-made fabrics having similar properties. In one example, flexible fabric substrate 12 may includes a tightly woven cotton-polyester blend. In such an example, this type of fabric may be used because resin compositions including heat-cured epoxy resins used to form plates 16 have been found to seep into and bond well with this substrate fabric. In some examples, substrate 12 may include a flexible and/or stretchable substrate such as a woven fabric commonly used for apparel or a non-woven fabric, or a flexible polymeric sheet or polymer film.

A guard plate, such as, e.g., guard plate 14 or guard plate 18 (FIGS. 11A and 11B), may be a 3-dimensional substantially solid plate formed of a cured polymeric composition that is bonded or otherwise attached to a surface of a fabric. In some example, a guard plate may have a substantially flat top surface (i.e., the surface of the guard plate substantially parallel to the top surface plane of substrate that the guard plate is formed on). In other example, a GP may include a dome-like top surface. A guard plate has a certain thickness protruding above the surface level of the substrate. When looked down from above the fabric substrate (referred to as the “top view”), a guard plate may have the shape of a polygon such as hexagon, pentagon, or other polygons. In some examples, a guard plate may also have a circular shape or an elliptic shape or oval shape. A guard plate may be comprised of a hard polymeric material such as a thermoset epoxy, which optionally may include one or more inorganic filler particles.

A guard plate may have the shape of any polygon in which any internal angle between two edges is less than about 180 degree (pi radian). A guard plate can also have any rounded shapes such as a circle, an ellipse, or an oval, which don't have concave boundaries. FIGS. 7A-7G illustrate various example shapes of guard plates 11A-11G, respectively. Other guard plates shapes are contemplated.

Size of a guard plate may be defined as the longest linear dimension of the shape of the guard plate. For example, the size of a guard plate of a circular shape is the diameter of the circle, and the size of a guard plate of hexagonal shape is the distance from a vertex of the hexagon to the farthest vertex among the remaining five vertexes. The size of a guard plate may range from about 0.2 millimeters to about 8 millimeters. However, other sizes are contemplated. In some examples, the size of a guard plate may range from about 3 millimeters to a few centimeters. In some examples, guard plate size is determined by the nature of intended applications Optimum size of guard plates may depend on the degree of bending or folding of the fabric including guard plates needed for particular applications. For example, tighter bending or folding of a fabric with guard plates may require smaller sizes of guard plates, while for applications requiring less tighter bending or folding of the fabric with guard plates may allow for larger sizes of guard plates. In some embodiments, a guard plate size may be in the range of about 1 mm to about 8 mm.

For a plurality of guard plates on the surface of a fabric substrate, the guard plates are separated from each other by gaps. The gaps may generally correspond to the portions of the fabric substrate that are not covered by guard plates, e.g., the uncovered surface of a fabric substrate between adjacent guard plates. When the guard plates are made of relatively hard abrasion protective materials that are substantially unflexible, a fabric substrate covered by guard plates with no gaps cannot be flexible. Accordingly, the gaps between guard plates may allow for flexibility and also, in many applications, for air and moisture permeability of a fabric substrate with guard plates. In some embodiments, the gap width between adjacent guard plates may be in the range of about 0.1 mm to about 2.5 mm.

The gaps between guard plates may form a continuous network. In some examples, when the guard plate patterns are polygons, the gaps may maintain a substantially constant width. In this case, the gaps may be thought of as line segments with finite widths equal to the gap width. The intersection of these line segments may be referred to as a ‘vertex’. The area of the guard plates near a vertex may be mechanically weaker than other parts of the guard plates since the guard plates come to a point near a vertex. The greater the number of gap ‘line segments’ that come together at a vertex, the weaker neighboring guard plates may become. In some examples, a fabric assembly may have a maximum of four gap ‘line segments’ converging at each vertex. Some vertices may have three gap ‘line segments’ converging. In some examples, it may be preferable to arrange guard plates in a pattern or patterns which minimizes the number of converging gap ‘line segments’ used. The hexagon shaped guard plates shown in FIG. 9A have only three gap ‘line segments’ at each vertex. The hexagon pattern has the desirable property of having no straight line gap alignments making the pattern provide for resistance to cutting and slicing with blades. In some instances, it may be desirable to have a guard plate geometry pattern with more flexibility than the hexagon pattern while keeping the overall abrasion and cut resistance of a large sized hexagon pattern.

A guard plate pattern may not be a substantially 2-dimensional pattern created on a substrate surface, which may be the case for typical screen-printed images or patterns on a T-shirt, for example. Rather, a guard plate pattern may be 3-dimensional in the sense that each guard plates has a thickness and protrudes away from (or out of) the surface of a fabric substrate. Such a feature is illustrated in FIGS. 11A and 11B, for example. The thickness of a guard plate may be defined as the averaged thickness of the part of a guard plate which protrudes above the substrate surface. In some examples, a guard plate may have a thickness that is more than 5 percent but less than 50 percent of the size of the guard plate. In some examples, a guard plate has a thickness of at least 4 mils, such as, e.g., at least 8 mils or at least 12 mils. In some embodiments the thickness of a guard plates may be in a range from about 0.1 mm to about 1.0 mm.

An aspect ratio for a guard plate may be defined as a dimensionless number obtained by dividing the size of the guard plate by the thickness of the guard plate. For example, an aspect ratio of five means that the size of a guard plate is 5 times of the thickness of the guard plate. In some examples, aspect ratio of guard plates of this disclosure may be in the range of about 2 to about 20. FIGS. 8A and 8B are conceptual diagrams illustrating cross-sectional views of guard plates 32 on fabric substrate 30. As shown, guard plates 30 in FIG. 8A have a difference size and thicknesses than the guard plates 30 in FIG. 8B, and, hence, different aspect ratios. In some examples, if the aspect ratio of a guard plate is too small, a vertical orientation of a guard plate may become unstable and the guard plate may tend to “tip over” under a shear stress. If the aspect ratio of a guard plate is too large, the guard plate may tend to break apart under a bending stress since the guard plate is a piece of a hard solid material. Selection of proper aspect ratio of a guard plate can depend on the nature of intended applications.

In some examples, the size of guard plates may range from about 1 mm to about 5 mm (e.g., about 0.04 inches to about 0.2 inches), preferably from about 1 mm to about 3 mm (e.g., about 0.04 inches to about 0.1 inches) and thickness of guard plates may range from about 0.1 mm about 1 mm (e.g., about 0.004 inches to about 0.04 inches).

FIGS. 9A-9D are conceptual diagrams illustrating different shapes and patterns of guard plates from a plan view (i.e., looking down from above the surface of the fabric substrate).

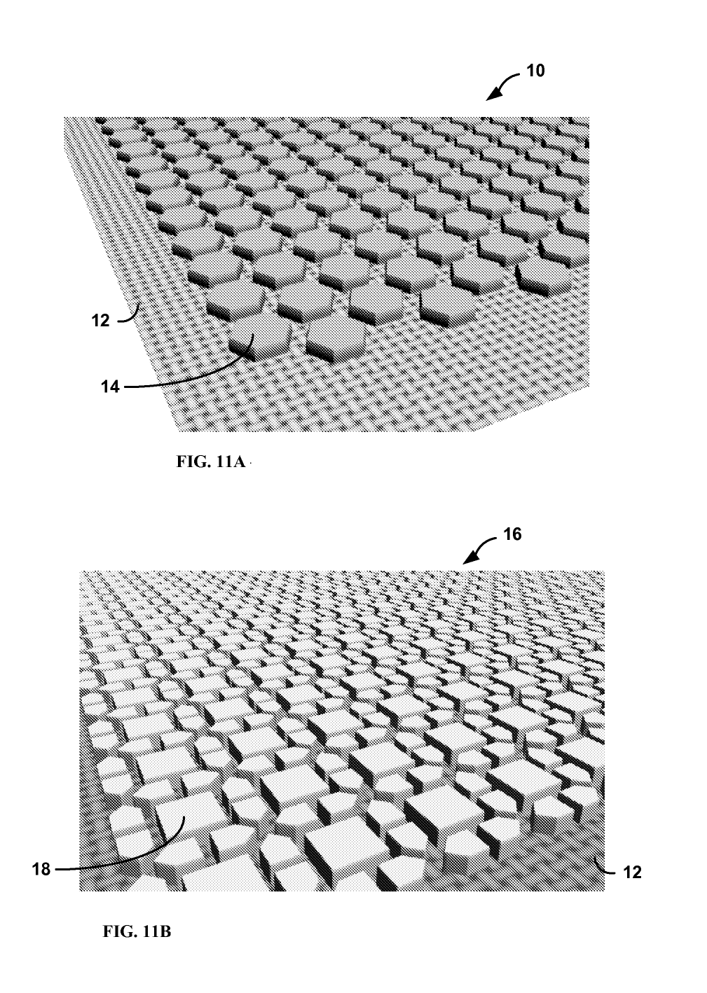

FIGS. 10A-10D are conceptual diagrams illustrating various vertical profiles of example GPs 36, 38, 40, 42, respectively, on fabric substrate 34. A guard plate can have variety of different vertical profiles including those shown in FIGS. 4A-4D. The vertical profile of a guard plate may generally refer to the shape of a guard plate when cut in half vertically. A vertical profile of a guard plate may have sharp corners at its edges, or well-rounded corners, or flat top surface or a dome-like over-all profile.

Referring to FIGS. 11A and 11B, plurality of plates 14, 18 may be affixed to the top surface of flexible fabric layer 12. Plates 14, 18 may be affixed to the surface of flexible fabric layer 12 via any suitable means. In some examples, the uncured polymeric resin of plates 14, 18 may be allowed to partially penetrate the surface of flexible fabric layer 12 after being deposited, e.g., printed, on layer 12, and then cured to provide mechanical attachment of plates 14, 18 to layer 12. In other examples, cured resin plates 14, 18 may be attached to the surface of flexible layer 12 using one or more suitable adhesives.

In some example, guard plates 14, 18 may be arranged on substrate 12 to impart abrasive, abrasion resistance, or other properties to fabric assemblies 10, 16 not normally exhibited by fabric substrate 12 without the presence of guard plates 14, 18. Guard plates 14, 18 may be formed of any suitable polymeric resin composition including, but not limited to, one or more example polymeric resin compositions described in published U.S. Patent Application No. 2007/0212965, entitled “Scrub Pad with Printed Rigid Plates and Associated Methods,” the entire content of which is hereby incorporated by reference. Plates 14, 18 may be formed of UV or thermal cureable polymeric compositions.

Suitable polymeric compositions for forming guard plates 14, 18 may include epoxy resin(s). In one embodiment, plates 14, 18 may be formed of heat-cured epoxy resin. Another example of an appropriate resin may be ultra-violet (UV) cured acrylate. Depending on the particular application, plates 14, 18 of fabric assembly 10, 16 may have a hardness between about 70 and about 100 Shore D, such as, e.g., between about 80 and about 95 Shore D. The hardness of plates 14, 18 may depend on a number of factors including, but not limited to, the polymeric resin composition used to form the plates and/or the process used to cure the polymeric resin composition after being deposited on the surface of flexible layer 12. In some embodiments the guard plates may comprise a thermoset epoxy. In some embodiments the guard plates may comprise inorganic filler particles. Thermally cured polymeric materials used for guard plates may be relatively hard and crack-resistant.

In some example, the polymer resin selected for use to form guard plates may ensure a strong bond between the guard plate and the fabric substrate base material. In some examples, a suitable polymer resin for construction of guard plates is a one-part heat-curable epoxy resin formulated to (i) provide abrasion resistance, (ii) be screen printable, (iii) be resistant to fracture, (iv) be bondable to the base material, and (v) have good shape definition during printing and curing of the guard plate material. Such resins may be readily formulated to meet these criteria and are available from, for example, Fielco Industries, Inc., Huntingdon Valley, Pa., 19006, which has formulated resins that may meet the characteristics set forth in this paragraph and has given them the designations: TR21 and TR84. Other examples of suitable resin formulations are available from Hexion Specialty Chemicals, Columbus, Ohio 43215. For example, Hexion Starting Formulation 4019 may be a suitable thermosetting heat curable epoxy base resin formulation. In some examples, abrasion resistance provided by guard plates can be increased by adding small particles (e.g., 1 to 100 micrometers) of silica, alumina, silicon carbide, titanium oxide and the like to the resin.

Additional information on embodiments of materials, including resins and fabrics, and processes that could be used to produce the guard plate geometries of this disclosure are described in U.S. Pat. No. 7,018,692 filed Dec. 31, 2001 and U.S. Pat. No. 6,962,739 filed Jul. 6, 2000 (both incorporated herein by reference). Another embodiment of this disclosure could be a second layer of polygons (guard plates) formed on top of a first layer of polygons (guard plates) as described in U.S. Pat. No. 7,018,692 filed Dec. 31, 2001. In some embodiments the fabric substrates for the designing fabric could be woven or nonwoven and made of natural, for example, cotton, or synthetic, such as polyester or nylon. The polymeric resin used for the polygons can be, as described above, themoset epoxy resin. The entire content of each of the patents and published patent applications described in this disclose is incorporated herein by reference.

In some embodiments, the use of low-wicking resin compositions to form guard plates 14, 18 may allow assemblies 10, 12 to maintain a relatively high degree of flexibility (e.g., substantially the same as that of substrate 12 without plates 14, 18) despite the presence of guard plates 14, 18. In some examples, during screen-printing or similar manufacturing processes of making polymeric resin plates on a fabric substrate, uncured polymeric materials tend to wick into the gaps between adjacent deposits. If the cured polymeric material of the plates is soft or rubbery, the wicking of the material before and/or during curing may not make the screen-printed fabric stiff, since the wicked portion of the material is still soft or rubbery after it is cured. However, if the cured material of plates is hard (for example, between about 80 to about 95 SHORE D hardness), the portion of the material wicked into gaps before and/or during curing may cause the screen-printed fabric to stiffen an undesirable amount. Using a low-wicking resin composition may allow for cured hard plates to be formed on the surface of flexible fabric layer 12 without substantially changing the flexibility of fabric layer 12 or scrub pad 10.

In some examples, a low-wicking polymeric resin composition may include one or more of an epoxy resin, phenolic resin, e.g., bakelite, polyester resin, polyurethane resin, polyimide resin, allyl resin, and the like. The polymeric resin may be a polymeric resin that irreversibly cross-links via a radiative process, such as, e.g., a thermal and/or UV process. In some examples, the polymeric resin formulation may include thermosetting resins and/or light turbo resins such as acrlyates, arylate copolymers, styrenes, and hybrids. Example epoxy resins may include Epon 828, a di-functional glycidyl ether based on bisphenol A, (obtained from Hexion Corporation, Columbus, Ohio), Epon 161, which is mulit-functional gylcidyl epoxy of a novolac oligomer (also available from Hexion), and/or Epon 160, which is a higher molecular weight analog of Epon 161 (also available from Hexion).

In some examples, the resin composition may include one or more additives. Additives may include one or more suitable curing agents, rheology modifiers, such as, e.g., one or more thixotropes, surfactants, dispersants, diluents, air release agents, fillers, colorants (dyes), glass beads, and/or the like. In some examples, a rheological modifier may impart yield stress on the resin composition, and may cause the resin composition to exhibit gel-like properties. In some examples, the resin composition may include one or more appropriate rheological modifiers from available from Hexion Corp, Columbus, Ohio 43215, such as, e.g., Heloxy Modifier 67. In some examples, the resin composition may include BYK 525, 555, which are bubble releasing materials from BYK USA, Wallingford, Conn.; BYK-9010, which is a wetting/dispersing aid also from BYK; and/or A-187, which is an epoxy functional silane available from GE Silicones. Examples colorants may include TiO₂, burnt umber, FD&C blue #2, cardinal pthalo blue, and BK 5099. In some examples, appropriate fillers may be included in the resin composition, such as, e.g., Imsil A30 available from Unimin Specialty Minerals, Inc, New Canaan, Conn. 06840.

### COMPARATIVE EXAMPLE

This example illustrates the improved resistance to abrasion when an image on a guard plate plus base fabric is protected by a polyurethane coating.

A decorative image was applied to a SuperFabric® sample by a dye sublimation process. The resulting fabric and image was then coated with a polyurethane solution consisting of Sancure 898+2% PZ-28 polyaziridine crosslinker in order to protect the image against abrasion. The coating was applied by hand using a foam brush and dried in an over at 65 degrees C. for 15 minutes. Multiple coats were applied in this manner with 2-4 coats providing optimal look, feel and abrasion resistance.

The dye sublimated image by itself was very thin, less than 0.5 mils (0.0127 mm), and when an unprotected dye sublimation image was subjected to a well known abrasion test using a Tabor Abrader with a 500 gram weight and a number H-18 abrasion wheel, the image at the tops of the guard plates was abraded away in approximately 5 turns. The polyurethane coated fabric, on the other hand, was abraded to a similar level after 30 turns. Since this is a very aggressive test, the improvement in abrasion resistance was determined to be very significant.

1. A fabric assembly comprising:
a flexible substrate including a top surface;
a plurality of plates affixed to the top surface of the flexible substrate and arrayed in a pattern such that a plurality of continuous gaps are defined between adjacent plates; and
a coating formed on at least one of the substrate and the plurality of guard plates, wherein the coating is selected to increase at least one of scuff resistance, oil resistance, water resistance, stain resistance of the fabric assembly.

2. The fabric assembly of claim 1, further comprising a material layer defining an image interposed between the plates and the coating.

3. The fabric assembly of claim 2, wherein the coating comprises one or more of polyurethane formulations, epoxy formulations, acrylic formulations, elastomeric emulsion, sputtered materials, chemical vapor deposited materials, dye sublimations, a film or structured film, or combinations thereof.

4. The fabric assembly of claim 2, wherein the coating comprises a coating with a surface energy less than 23 dynes per cm.

5. The fabric assembly of claim 2, wherein the coating comprises a coating with a surface energy less than 35 dynes per cm.

6. The fabric assembly of claim 2, wherein the coating comprises a coating with a surface energy less than 50 dynes per cm.

7. The fabric assembly of claim 2, wherein the coating comprises a coating with a Sward Rocker Hardness greater than 25.

8. The fabric assembly of claim 2, wherein the coating comprises a coating with a Sward Rocker Hardness greater than 35.

9. The fabric assembly of claim 2, wherein the coating comprises a coating with a Sward Rocker Hardness greater than 45.

10. The fabric assembly of claim 2, wherein the coating comprises a coating configured to substantially control radiation reflection of the fabric assembly.

11. The fabric assembly of claim 2, wherein the coating comprises a coating configured to control radiation penetration to the fabric assembly.

12. The fabric assembly of claim 2, wherein the coating is selected to increase water resistance, wherein the water resistance is asymmetric such that passage of water is allowed in one direction through the fabric but substantially not allowed in a reverse direction.

13. The fabric assembly of claim 2, wherein the image is produced by a dye sublimation process.

14. The fabric assembly of claim 1, wherein the coating comprises one or more of polyurethane formulations, epoxy formulations, acrylic formulations, elastomeric emulsion, sputtered materials, chemical vapor deposited materials, a film or structured film, or combinations thereof.

15. The fabric assembly of claim 1, wherein the coating comprises a coating with a surface energy less than 23 dynes per cm.

16. The fabric assembly of claim 1, wherein the coating comprises a coating with a surface energy less than 35 dynes per cm.

17. The fabric assembly of claim 1, wherein the coating comprises a coating with a surface energy less than 50 dynes per cm.

18. The fabric assembly of claim 1, wherein the coating comprises a coating with a Sward Rocker Hardness greater than 25.

19. The fabric assembly of claim 1, wherein the coating comprises a coating with a Sward Rocker Hardness greater than 35.

20. The fabric assembly of claim 1, wherein the coating comprises a coating with a Sward Rocker Hardness greater than 45.

21. The fabric assembly of claim 1, wherein the coating comprises a coating configured to substantially control radiation reflection of the fabric assembly.

22. The fabric assembly of claim 1, wherein the coating comprises a coating configured to control radiation penetration to the fabric assembly.

23. A method comprising:
forming a coating on at least a portion of a fabric assembly, the fabric assembly including a flexible substrate including a top surface, and a plurality of plates affixed to the top surface of the flexible substrate and arrayed in a pattern such that a plurality of continuous gaps are defined between adjacent plates, wherein forming the coating comprises forming the coating on at least one of the substrate and the plurality of guard plates to increase at least one of scuff resistance, oil resistance, water resistance, stain resistance of the fabric assembly.

24. A fabric assembly comprising:
a flexible substrate including a top surface; and
a plurality of plates affixed to the top surface of the flexible substrate and arrayed in a pattern such that a plurality of continuous gaps are defined between adjacent plates, wherein the plates have a modified surface to form a selected image, wherein the modified surface includes at least one of a surface altered via altering the chemistry of the surface, a surface altered via texturing of the surface, or a surface altered via application of a material to the surface.

25. The fabric assembly of claim 24, wherein the modified surface is formed by at least one of laser ablation, plasma treatment, nano-imprinting, nano-patterning, chemical etching.

26. The fabric assembly of claim 24, wherein the surface modification is configured to control radiation reflection of the fabric assembly.

27. The fabric assembly of claim 24, wherein the surface modification is configured to control the hydrophobicity of the fabric assembly.

28. A method comprising:
forming a plurality of guard plates on a surface of a flexible substrate, wherein the guard plates are affixed to the top surface of the flexible substrate and arrayed in a pattern such that a plurality of continuous gaps are defined between adjacent plates; and
modifying a surface of each of the plurality of guard plates to form a selected image, wherein modifying the surface includes at least one of altering the chemistry of the surface, texturing of the surface, or applying a material to the surface.
